(19) United States
(12) Patent Application Publication
(10) Pub. No.: US 2018/0217916 A1
(43) Pub. Date: Aug. 2, 2018

(54) LOCAL SOFTWARE SIMULATION ENVIRONMENT

(71) Applicant: salesforce.com, inc., San Francisco, CA (US)

(72) Inventors: Matthew Scott Musser, Longmont, CO (US); Michael Christopher Olson, Oconomowoc, WI (US)

(21) Appl. No.: 15/419,488

(22) Filed: Jan. 30, 2017

(51) Int. Cl. G06F 11/36; G06F 17/50; G06F 9/455

(52) U.S. Cl. CPC G06F 11/3604; G06F 9/45508; G06F 17/5009

(57) ABSTRACT

In various embodiments, a method of implementing a local simulation environment may be performed. The method may include implementing a network-based computing platform that executes applications received from a plurality of clients. The network-based computing platform may include a network-based software development environment. The method may further include providing a local simulation environment to a client. The local simulation environment may constitute a subset of the functionality of the network-based software development environment. The local simulation environment may prevent the client from accessing administrator features of the local simulation environment. The method may further include receiving, from the client, an application executable on the network-based computing platform.

### BACKGROUND

Cloud application development platforms, such as the Force.com multitenant architecture, may allow individual enterprises and software as a service (SaaS) vendors to develop robust, reliable, and Internet-scale applications. Web applications may access various types of data, e.g., by accessing a database and processing accessed information.

### BRIEF DESCRIPTION OF THE DRAWINGS

FIG. 1 is a block diagram illustrating an exemplary environment for a multi-tenant database system, according to some embodiments.

FIG. 2 is a block diagram illustrating an exemplary multi-tenant database system in more detail, according to some embodiments.

FIG. 3 is a block diagram illustrating a first exemplary implementation of a local software simulation environment.

FIG. 4 is a block diagram illustrating a second exemplary implementation of a local software simulation environment.

FIG. 5 is a flow diagram illustrating an exemplary method of providing a local simulation environment.

FIG. 6 is a flow diagram illustrating an exemplary method of implementing a local simulation environment.

This specification includes references to various embodiments, to indicate that the present disclosure is not intended to refer to one particular implementation, but rather a range of embodiments that fall within the spirit of the present disclosure, including the appended claims. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “processing element configured to store manageable state information” is intended to cover, for example, an element that performs this function during operation, even if the circuit in question is not currently being used (e.g., power is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function. After appropriate programming, the FPGA may then be configured to perform that function.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

### DETAILED DESCRIPTION

A local software simulation environment is disclosed herein that provides a client at least a subset of functionalities provided by a network-based software development environment. In some cases, the local software simulation environment may be used in lieu of the network-based software development environment for developing applications. The local software simulation environment may include one or more security features that prevent the client from accessing one or more administrator features of the local software simulation environment. In various embodiments, the local software simulation environment may be implemented using a client's existing computer system (e.g., as a virtual machine). In some embodiments, the local software simulation environment may be implemented by sending a computer system to the client. Because the client can use the local software simulation environment using a local computer system,

As used herein, a “network-based software development environment” refers to an environment implemented by servers of an entity, where the entity allows clients to access the servers to at least test some types of application code. The clients may remotely connect to the servers, send the application code to the servers, and receive results of execution of the code from the servers. In some cases, the network-based software development environment and the application code may be specific to a programming language corresponding to a service or product provided by the entity.

The present disclosure makes references to a “local computer system.” This phrase refers to a computer system of a client to a “network-based development environment” as defined above. This term is intended to be interpreted broadly and does not necessarily connote direct physical access or a same physical location. For example, the computer system may be remote to the client and the client may interact with the local computer system via a remote desktop connection. However, this also does not exclude, for example cases where the client uses one or more physical interfaces (e.g., a mouse and keyboard) to directly interact with a local computer system.

As used herein, the term “administrator features” is to be interpreted according to its ordinary and accepted meaning in the art, including at least actions that require access to a kernel or command prompt of a program are considered herein as being administrator features.

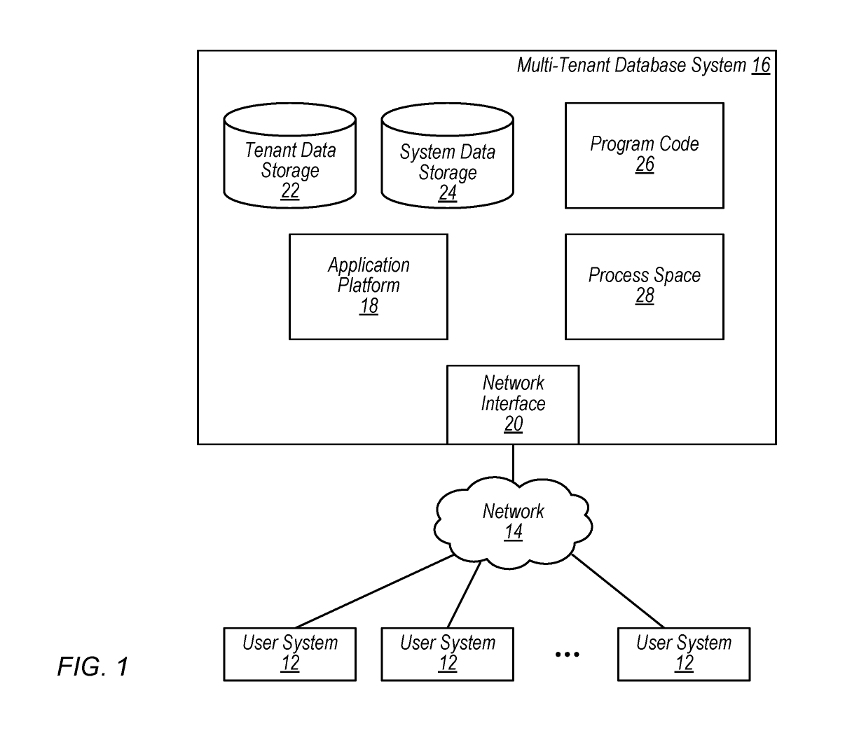

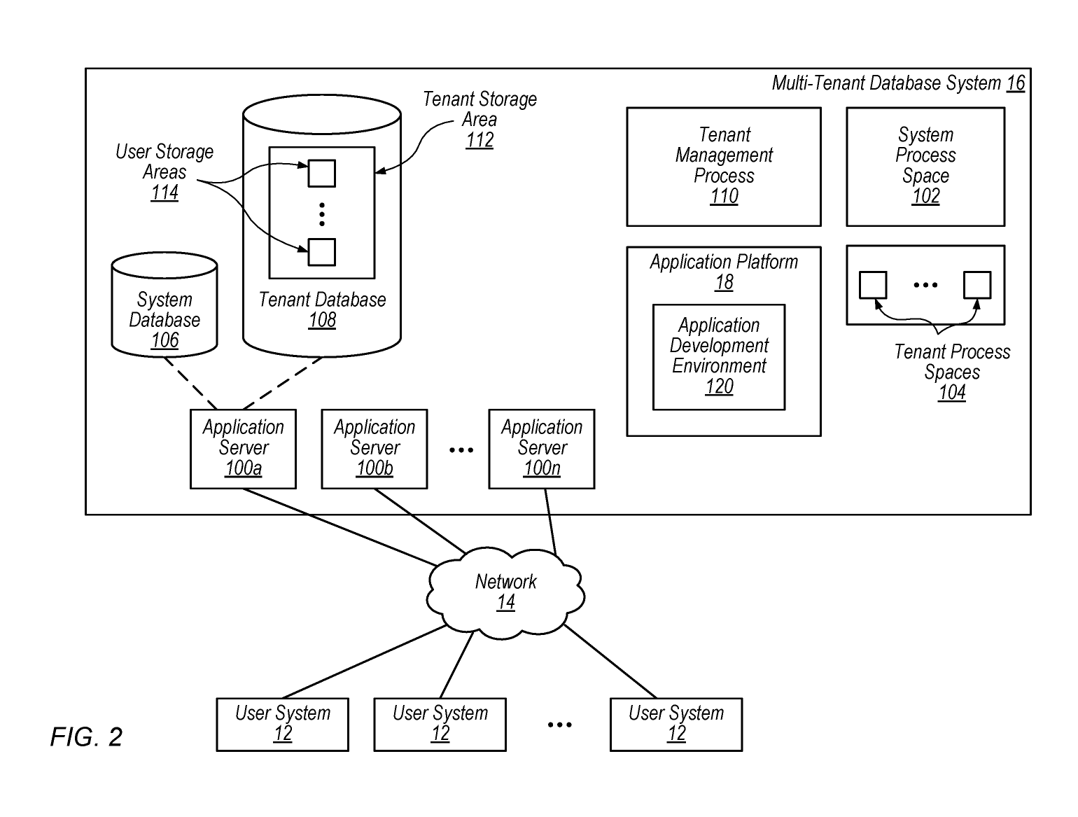

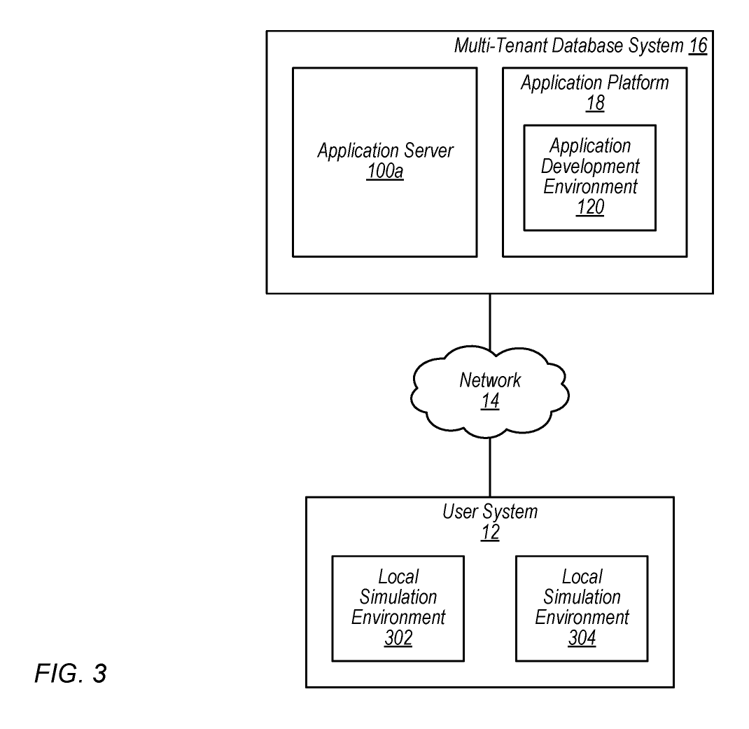

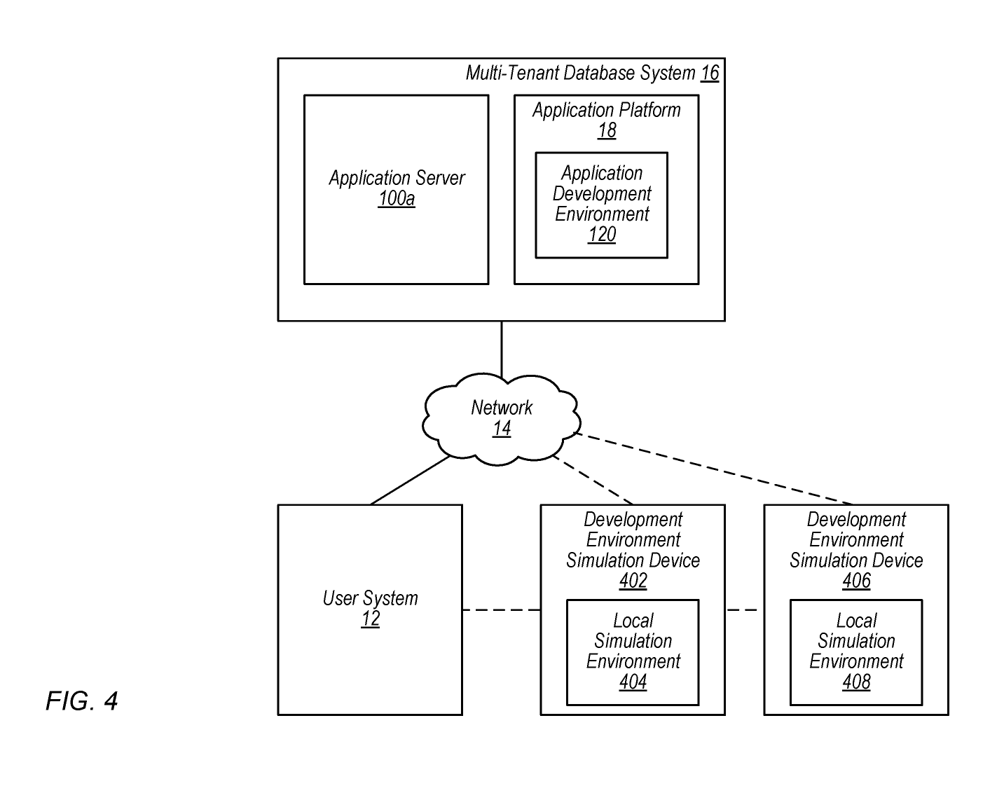

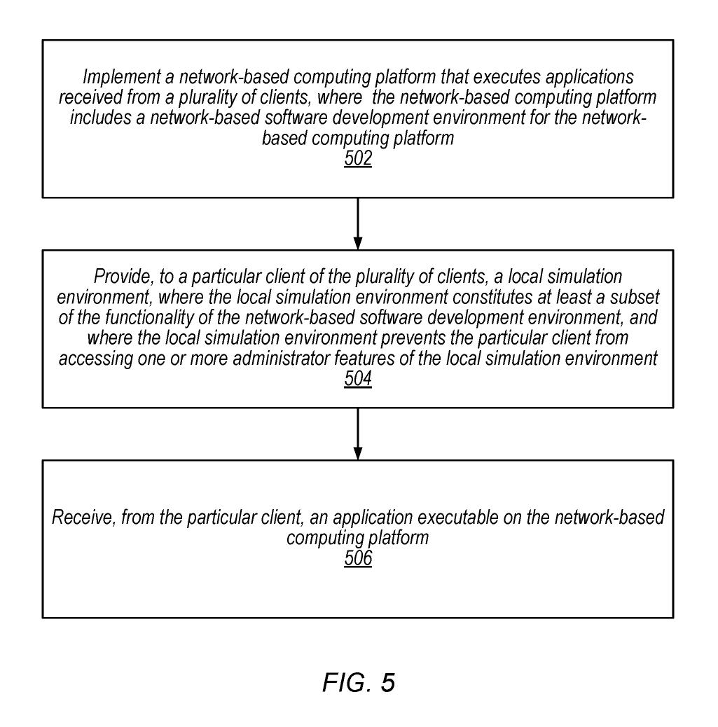

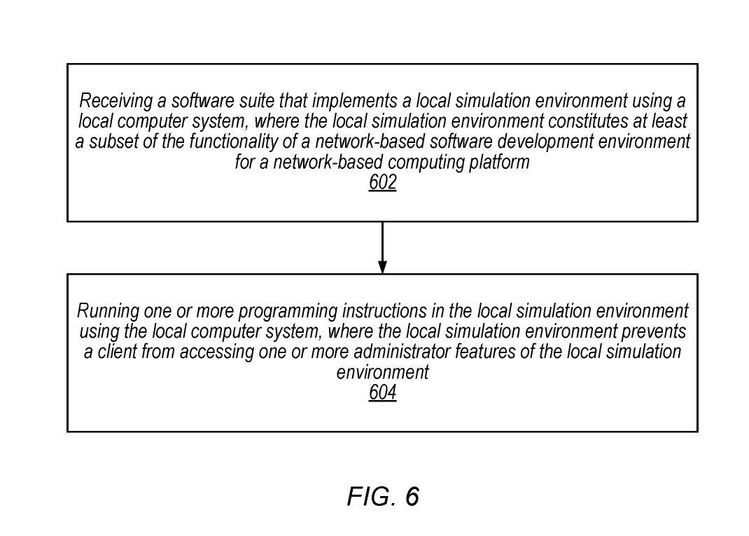

This disclosure initially describes, with reference to FIGS. 1-2, various embodiments of an exemplary multi-tenant database system that includes an application platform. Exemplary implementations of a local software simulation environment are described with reference to FIGS. 3-4. A method of providing a local simulation environment to a client is described with reference to FIG. 5. A method of implementing a local simulation environment is described with reference to FIG. 6.

FIG. 1 illustrates an exemplary environment in which a local software simulation environment may be implemented. Note that the disclosed multi-tenant systems are included to illustrative purposes but are not intended to limit the scope of the present disclosure. In other embodiments, similar techniques may be implemented in non-multi-tenant environments such as various client/server environments, cloud computing environments, clustered computers, etc. As illustrated in FIG. 1 (and in more detail in FIG. 2) one or more user systems 12 may interact via a network 14 with a multi-tenant database system (MTS) 16. MTS 16 may store information from one or more tenants stored into tables of a common database image. A database image may include one or more database objects. A relational database management system (RDMS), object oriented database management system (OODBMS) or the like may execute storage and retrieval of information against the database object(s). MTS 16 may include an application platform 18 that enables creation, managing and executing one or more applications developed by the provider of MTS 16, users accessing the MTS 16 via user system 12, or third party application developers accessing MTS 16 via user system 12. In some embodiments, MTS 16 may be a network-based computing platform.

The users of user systems 12 may be users in differing capacities and the capacity of a particular user system 12 might be determined one or more permission levels associated with the current user. For example, when a salesperson is using a particular user system 12 to interact with MTS 16, that user system 12 may have capacities allotted to that salesperson. However, when an administrator is using the same user system 12 to interact with MTS 16, the user system 12 may have capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users may have different capabilities with regard to accessing and modifying application and database information, depending on a user's security or permission level.

Network 14 may be a LAN (local area network), WAN (wide area network), wireless network, point-to-point network, star network, token ring network, hub network, or any other appropriate configuration. The global internetwork of networks often referred to as the “Internet” with a capital “I,” will be used in many of the examples herein and is one example of a TCP/IP (Transfer Control Protocol and Internet Protocol) network. It should be understood, however, that the disclosed embodiments may utilize any of various other types of networks.

User systems 12 may communicate with MTS 16 using TCP/IP and, at a higher network level, use other common Internet protocols to communicate, such as HTTP, FTP, AFS, WAP, etc. As an example, where HTTP is used, user system 12 might include an HTTP client commonly referred to as a “browser” for sending and receiving HTTP messages from an HTTP server at MTS 16. Such a server might be implemented as the sole network interface between MTS 16 and network 14, but other techniques might be used as well or instead. In some implementations, the interface between MTS 16 and network 14 includes load sharing functionality, such as round-robin HTTP request distributors to balance loads and distribute incoming HTTP requests evenly over a plurality of servers. In some cases, each of the plurality of servers has access to data stored on the MTS 16, at least for the users that are accessing a server.

In some embodiments, the system shown in FIG. 1 implements a web-based customer relationship management (CRM) system. For example, in some embodiments, MTS 16 includes application servers configured to implement and execute CRM software applications as well as provide related data, code, forms, web pages and other information to and from user systems 12 and to store to, and retrieve from, a database system related data, objects and web page content. In embodiments of a multi-tenant system, tenant data may be arranged such that data of one tenant is kept separate from that of other tenants so that that one tenant does not have access to another tenant's data, unless such data is expressly shared. In various embodiments, MTS 16 implements applications other than, or in addition to, a CRM application. For example, MTS 16 may provide user systems 12 access to multiple hosted (standard and/or custom) applications, including a CRM application. User (or third party developer) applications, which may or may not include CRM, may be supported by the application platform 18. In particular, application platform 18 may manage creation of the applications, testing of the applications, storage of the applications into one or more database objects, execution of the applications in a virtual machine of process space 28, or any combination thereof.

One arrangement of elements of MTS 16 is shown in FIG. 1, including application platform 18, network interface 20, storage 22 for tenant data, storage 24 for system data accessible to MTS 16 and possibly multiple tenants, program code 26 for implementing various functions of MTS 16, and a process space 28 for executing MTS system processes and tenant-specific processes, such as running applications as part of an application service.

Several elements in the system shown in FIG. 1 may include conventional, well-known elements that need not be explained in detail here. For example, each user system 12 may be a desktop personal computer, workstation, laptop, PDA, cell phone, or any Wireless Access Protocol (WAP) enabled device or any other computing device capable of interfacing directly or indirectly to the Internet or other network connection. In some cases, user system 12 may include dedicated hardware configured to interface with MTS 16 over network 14. User system 12 may execute an HTTP client, e.g., a browsing program, such as Microsoft's Internet Explorer™ browser, Netscape's Navigator™ browser, Opera's browser, or a WAP-enabled browser in the case of a cell phone, PDA or other wireless device, or the like, allowing a user (e.g., subscriber of a CRM system) of user system 12 to access, process, and view information and pages available to it from MTS 16 over network 14. Each user system 12 may include one or more user interface devices, such as a keyboard, a mouse, touch screen, pen or the like, for interacting with a graphical user interface (GUI) provided by the browser on a display monitor screen, LCD display, etc. in conjunction with pages, forms and other information provided by MTS 16 or other systems or servers. As discussed above, disclosed embodiments are suitable for use with the Internet, which refers to a specific global internetwork of networks. It should be understood, however, that other networks may be used instead of the Internet, such as an intranet, an extranet, a virtual private network (VPN), a non-TCP/IP based network, any LAN or WAN or the like.

In some embodiments, each user system 12 and its components are operator configurable using applications, such as a browser, that include computer code executable on one or more processing elements. Similarly, in some embodiments, MTS 16 (and additional instances of MTSs, where more than one is present) and their components are operator configurable using application(s) that include computer code executable on one or more processing elements. Thus, various operations described herein may be performed by executing program instructions stored on a non-transitory computer-readable medium and executed by one or more processing elements. The program instructions may be stored on a non-volatile medium such as a hard disk, or may be stored in any other volatile or non-volatile memory medium or device as is well known, such as a ROM or RAM, or provided on any media capable of staring program code, such as a compact disk (CD) medium, digital versatile disk (DVD) medium, a floppy disk, and the like. Additionally, the entire program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the disclosed embodiments can be implemented in any programming language that can be executed on a server or server system such as, for example, in C, C+, HTML, Java, JavaScript, or any other scripting language, such as VBScript.

According to some embodiments, each MTS 16 is configured to provide web pages, forms, applications, data, and/or media content to user systems 12 to support the access by user systems 12 as tenants of MTS 16. As such, in this embodiment, MTS 16 provides security mechanisms to keep each tenant's data separate unless the data is shared. If more than one server is used, they may be located in close proximity to one another (e.g., in a server farm located in a single building or campus), or they may be distributed at locations remote from one another (e.g., one or more servers located in city A and one or more servers located in city B). As used herein, MTSs may include one or more logically and/or physically connected servers distributed locally or across one or more geographic locations. Additionally, the term “server” includes a computer system, including processing hardware and process space(s), and an associated storage system and database application as is well known in the art. It should also be understood that “server system” and “server” are often used interchangeably herein. Similarly, the databases described herein can be implemented as single databases, a distributed database, a collection of distributed databases, a database with redundant online or offline backups or other redundancies, etc., and might include a distributed database or storage network and associated processing intelligence.

FIG. 2 illustrates exemplary embodiments of an MTS 16 and various interconnections in more detail. In this example, the network interface is implemented as one or more HTTP application servers 100a-n, application platform 18, system database 106, and tenant database 108. Also shown is application platform 18, system process space 102, individual tenant process spaces 104, a system database 106, tenant database(s) 108 and a tenant management process 110. In various embodiments, tenant database 108 may be sharded across application servers 100a-n and may be divided into individual tenant storage areas 112. Within each tenant storage area 112, user storage areas 114 may be allocated for each user. For example, a copy of a user's most recently used (MRU) items might be stored in a corresponding user storage area 114. Similarly, a copy of MRU items for an entire organization that is a tenant might be stored in tenant storage area 112. In some embodiments, application servers 100a-n may include or implement one or more of tenant management process 110, system process space 102, tenant process spaces 104, application platform 18, or any combination thereof.

Application platform 18 includes an application development environment 120 that supports application developers' creation and management of applications. In some embodiments, applications may be saved as metadata into tenant database 108 for execution by subscribers (e.g., an application developer or other users or tenants) as one or more tenant processes in tenant process spaces 104. The one or more tenant processes may be managed by tenant management process 110. In some embodiments, application development environment 120 may provide a programming language style interface extension to user systems 12. In various embodiments, application development environment 120 may be a network-based software development environment.

It should also be understood that each application server 100 may be configured to communicate with various database systems, e.g., system database 106 and tenant database(s) 108, via, a different network connection. For example, one application server 100a might be coupled via the network 14, another server 100b might be coupled via a direct network link, and another server 100n might be coupled by yet a different network connection. Transfer Control Protocol and Internet Protocol (TCP/IP) are exemplary protocols for communicating between application servers 100 and the database system, however, it will be apparent to one skilled in the art that other transport protocols may be used depending on the network interconnect used.

In some embodiments, each application server 100 is configured to handle requests for any user/organization. Because it is desirable to be able to add and remove application servers from the server pool at any time for any reason, there may be no server affinity for a user and/or organization to a specific application server 100. In some embodiments, therefore, an interface system (not shown) implementing a load balancing function (e.g., an F5 Big-IP load balancer) is located between the application servers 100 and the user systems 12 and is configured to distribute requests to the application servers 100. In some embodiments, the load balancer uses a least connections algorithm to route user requests to the application servers 100. Other examples of load balancing algorithms, such as are round robin and observed response time, also can be used. For example, in certain embodiments, three consecutive requests from the same user could hit three different servers, and three requests from different users could hit the same server. In this manner, MTS 16 is multi-tenant, wherein the MTS 16 handles storage of different objects and data across disparate users and organizations.

As an example of storage, one tenant might be a company that employs a sales force where each salesperson uses MTS 16 to manage their sales process. Thus, a user might maintain contact data, leads data customer follow-up data, performance data, goals and progress data, all applicable to that user's personal sales process (e.g., in tenant database 108). In some MTS embodiments, since all of this data and the applications to access, view, modify, report, transmit, calculate, eta, can be maintained and accessed by a user system having nothing more than network access, the user can manage his or her sales efforts and cycles from any of many different user systems. For example, if a salesperson is paying a visit to a customer and the customer has Internet access in their lobby, the salesperson can obtain critical updates as to that customer while waiting for the customer to arrive in the lobby.

Although each user's sales data may be separate from other users' sales data regardless of the employers of each user, some data may be organization-wide data shared or accessible by a plurality or all of the sales for a given organization that is a tenant. Thus, there may be some data structures managed by MTS 16 that are allocated at the tenant level while other data structures are managed at the user level. Because an MTS may support multiple tenants including possible competitors, the MTS should have security protocols that keep data, applications and application use separate. Also, because many tenants will opt for access to an MTS rather than maintain their own system, security, redundancy, up-time and backup are more critical functions and need to be implemented in the MTS.

In addition to user-specific data and tenant-specific data, MTS 16 might also maintain system level data usable by multiple tenants. Such system level data might include industry reports, news, postings, and the like that are sharable among tenants.

In certain embodiments, client user systems 12 communicate with application servers 100 to request and update system-level and tenant-level data from MTS 16 that may require one or more queries to system database 106 and/or tenant database 108. In some embodiments, MTS 16 automatically generates one or more SQL statements (the SQL query) designed to access the desired information.

Each database may generally be viewed as a set of logical tables containing data fitted into predefined categories. Each table typically contains one or more data categories logically arranged in physical columns. Each row of a table typically contains an instance of data for each category defined by the columns. For example, a CRM database may include a table that describes a customer with columns for basic contact information such as name, address, phone number, fax number, etc. Another table may describe a purchase order, including columns for information such as customer, product, sale price, date, etc.

Each database can generally be viewed as a collection of objects, such as a set of logical tables, containing data fitted into predefined categories. A “table” is one representation of a data object, and is used herein to simplify the conceptual description of objects and custom objects according to disclosed embodiments. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead and Opportunity data, each containing pre-defined fields.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain aspects, for example, all custom entity data rows are stored in a single multi-tenant physical table, which may contain multiple logical tables per organization. It may be transparent to customers that their multiple “tables” are in fact stored in one large table or that their data may be stored in the same table as the data of other customers.

Turning now to FIG. 3, a block diagram illustrating an example implementation of a local simulation environment. In the illustrated embodiment, MTS 16, network 14, and user system 12 are shown. MTS 16 includes application server 100a and application platform 18. Application platform 18 includes application development environment 120. Additionally, user system 12 includes local simulation environment 302 and local simulation environment 304. For clarity, some portions of MTS 16 are not shown. Although specific hardware from FIGS. 1 and 2 is illustrated, in other embodiments, other hardware may instead or additionally be used.

As discussed above, MTS 16 may implement an application platform 18 that may be used to run and distribute user applications. In some cases, the user applications may be tested using application development environment 120. In particular, the user applications may be run using physical computing devices (e.g., one or more processors) or MTS. In some cases, MTS 16 may encounter resource contention problems as a result of receiving too many requests to run applications within a particular amount of time relative to available computing devices of MTS 16. In some embodiments, MTS 16 may implement various rules to reduce a likelihood of potential resource contention problems. For example, MTS 16 may restrict clients (e.g., a client associated with user system 12) to submitting a particular number of requests to initiate applications associated with the client (e.g., fifty requests) within a particular duration (e.g., one day). As another example, MTS 16 may restrict clients to running applications for a particular amount of time (e.g., two hours) within a particular duration (e.g., one day).

In the illustrated embodiment, a client may implement a local simulation environment (e.g., local simulation environment 302) for various reasons, such as if the client wishes to perform testing more frequently or if the client simply wishes to perform testing locally. Local simulation environment 302 may be a programming environment implemented using local computing resources of a local computer system of the client. Local simulation environment 302 may implement at least a subset of functionality provided by application development environment 120. For example, local simulation environment 302 may be programmed such that the local computer system may run at least some application code in a manner similar to how the application code would be run using application development environment 120. Thus, the client may use local simulation environment 302 for application development, running variations of programming instructions prior to sending the programming instructions to MTS 16. Local simulation environment 302 may enable a client to run applications locally, enabling the client to avoid application restrictions of application development environment 120.

In the illustrated embodiment, local simulation environment 302 is implemented as a virtual machine on user system 12. Accordingly, local simulation environment 302 may be downloaded from MTS 16 via application server 100a. For example, in some embodiments, a client associated with user system 12 may request a local simulation environment. In response to the request, user system 12 may download (e.g., via application server 100a and network 14) local simulation environment 302 from MTS 16. However, as described below with reference to FIG. 4, in other embodiments, local simulation environment 302 may be implemented by an entity associated with MTS 16 sending a computer system configured to implement the local simulation environment to a client associated with user system 12.

In various embodiments, local simulation environment 302 may disable one or more administrator features of user system 12. For example, local simulation environment 302 may prevent a user of user system 12 from accessing a command prompt of user system 12 while local simulation environment 302 is running. As another example, local simulation environment 302 may prevent a user of user system 12 from accessing an operating system kernel of the virtual machine used to implement local simulation environment 302. As another example, local simulation environment 302 may prevent user system 12 from communicating using one or more network connections or may restrict communications to a particular set of internet protocol (IP) addresses or network ports. As a result, local simulation environment 302 may protect data associated with implementing local simulation environment 302.

In some cases, user system 12 may contact MTS 16 to request administrative support for local simulation environment 302 or a refresh of a software image used to implement local simulation environment 302. Additionally, in some cases, MTS 16 may provide user system 12 with one or more updates to local simulation environment 302. In some embodiments, a computer associated with MTS 16 (e.g., a computer of an administrator of MTS 16) may access the one or more administrator features (e.g., in response to providing an administrator password).

As noted above, in some embodiments, local simulation environment 302 may implement a subset of features provided by application development environment 120. In various embodiments, the local simulation environment system described herein may be modular. As a result, local simulation environment 304 may additionally be provided. In the illustrated embodiment, local simulation environment 304 may correspond to at least one different feature provided by application development environment 120, as compared to local simulation environment 302. For example, in some cases, local simulation environment 302 may correspond to a particular group of programming instructions and local simulation environment 304 may correspond to a different group of programming instructions. In some cases, local simulation environment 304 may correspond to one or more on-demand features that are not included within local simulation environment 302 (e.g., because the on-demand features are only used in specific applications and because the data used to support the on-demand features would consume more than a predetermined threshold amount of the data used to implement local simulation environment 302). In some embodiments, local simulation environment 302 may be restricted to a single computing device (e.g., a single computer). Local simulation environment 304 may be provided and associated with a different computing device so additional computing resources may be used. Further, local simulation environment 304 may be provided so the client may implement applications that use multiple computing devices (e.g., distributed applications). In some embodiments, local simulation environment 304 may be a standalone local simulation environment. In other embodiments, local simulation environment 304 may cause local simulation environment 302 to provide the additional features corresponding to local simulation environment 304. Although, in the illustrated embodiment, user system 12 includes two local simulation environments, in some embodiments, user system 12 only includes a single local simulation environment. In other embodiments, user system 12 includes more than two local simulation environments. In some embodiments, user system 12 may include multiple computer systems that implement multiple local simulation environments (e.g., three computer systems that implement four local simulation environments).

In some cases, a client may implement local simulation environment 302, local simulation environment 304, or both as an alternative to or as a way of reducing a cost of paying to test applications using application development environment 120. MTS 16 may provide local simulation environment 302 for free or at a reduced cost, as compared to using application development environment 120 as a way of reducing a number of requests to use application development environment 120. Clients running applications locally may reduce a number of requests from the clients to application development environment 120.

Turning now to FIG. 4, a block diagram illustrating an example implementation of a local simulation environment. In the illustrated embodiment, MTS 16, network 14, user system 12, and development environment simulation devices 402 and 406 are shown. MTS 16 includes application server 100a and application platform 18. Application platform 18 includes application development environment 120. Development environment simulation device 402 includes local simulation environment 404. Development environment simulation device 406 includes local simulation environment 408. For clarity, some portions of MTS 16 are not shown. Although specific hardware from FIGS. 1 and 2 is illustrated, in other embodiments, other hardware may instead or additionally be used.

In the illustrated embodiment, MTS 16 may function in a manner similar to that described above with reference to FIG. 3. However, in response to a request via user system 12, an entity associated with MTS 16 (e.g., a member of an organization that manages MTS 16) may send development environment simulation device 402 to a client associated with user system 12. Development environment simulation device 402 may be dedicated hardware configured to implement local simulation environment 404. In other embodiments, development environment simulation device 402 may be a general purpose computer that includes a local simulation environment similar to local simulation environment 302 of FIG. 3.

Similar to local simulation environment 302 of FIG. 3, a user of development environment simulation device 402 may be prevented from accessing one or more administrator features (e.g., based on instructions associated with local simulation environment 404 or based on one or more hardware features of development environment simulation device 402). For example, a user of development environment simulation device 402 may be prevented from accessing a command prompt of development environment simulation device 402 (e.g., while local simulation environment 404 is running or generally). As another example, a user of development environment simulation device 402 may be prevented from accessing an operating system kernel of development environment simulation device 402. As another example, a user of development environment simulation device 402 may be prevented from communicating using one or more network connections or may restrict communications to a particular set of internet protocol (IP) addresses or network ports. To illustrate, local simulation environment 404 may disable various ports of development environment simulation device 402 or development environment simulation device 402 may be configured such that the various ports are disabled. As a result, data associated with implementing local simulation environment 404 may be protected.

In some cases, development environment simulation device 402 may contact MTS 16 to request administrative support for local simulation environment 404 or a refresh of a software image used to implement local simulation environment 404. The communications may be performed via user system 12 or directly. Additionally, in some cases, MTS 16 may provide development environment simulation device 402 with one or more updates to local simulation environment 404. In some embodiments, a computer associated with MTS 16 (e.g., a computer of an administrator of MTS 16) may access the one or more administrator features (e.g., in response to providing an administrator password).

As noted above, in some embodiments, local simulation environment 404 may implement a subset of features provided by application development environment 120. In various embodiments, the local simulation environment system described herein may be modular. As a result, development environment simulation device 406, including local simulation environment 408, may additionally be provided. In the illustrated embodiment, local simulation environment 408 may correspond to at least one different feature provided by application development environment 120, as compared to local simulation environment 404. For example, in some cases, local simulation environment 404 may correspond to a particular group of programming instructions and local simulation environment 408 may correspond to a different group of programming instructions. In some cases, local simulation environment 408 may correspond to one or more on-demand features that are not included within local simulation environment 404 (e.g., because the on-demand features are only used in specific applications and because the data used to support the on-demand features would consume more than a predetermined threshold amount of the resources of development environment simulation device 402). Further, local simulation environment 408 may be provided so the client may implement applications that use multiple computing devices (e.g., distributed applications). In some embodiments, local simulation environment 408 may be a standalone local simulation environment. In other embodiments, local simulation environment 408 may expand the functionality of local simulation environment 404, causing local simulation environment 404 to provide the additional features corresponding to local simulation environment 408. In some embodiments, development environment simulation devices 402 and 406 may be networked together such that a user of user system 12 may use functionalities of local simulation environments 404 and 408 by sending instructions to a single development environment simulation device. Development environment simulation device 402 may be configured to communicate directly or may be configured to communicate via user system 12. Although the illustrated embodiment includes multiple development environment simulation devices, in some embodiments, only a single development environment simulation device is included. In other embodiments, more than two development environment simulation devices are included.

Referring now to FIG. 5, a flow diagram of a method of providing a local simulation environment is depicted. In some embodiments, the method may be initiated or performed by one or more processors in response to one or more instructions stored by a computer-readable storage medium.

At 502, the method includes implementing a network-based computing platform that executes applications received from a plurality of clients. The network-based computing platform may include a network-based software development environment for the network-based computing platform. For example, MTS 16 of FIG. 2 may execute applications received from clients via user systems 12. MTS 16 includes application development environment 120.

At 504, the method includes providing, to a particular client of the plurality of clients, a local simulation environment. The local simulation environment may constitute at least a subset of the functionality of the network-based software development environment. The local simulation environment may prevent the particular client from accessing one or more administrator features of the local simulation environment. For example, MTS 16 may provide, to a client associated with user system 12 of FIG. 3, local simulation environment 302. As another example, MTS 16 may provide, to a client associated with user system 12 of FIG. 4, development environment simulation device 402 including local simulation environment 404.

At 506, the method includes receiving, from the particular client, an application executable on the network-based computing platform. For example, MTS 16 may receive, from user system 12, an application executable on a device of MTS 16 (e.g., within tenant process spaces 104, system process space 102, or elsewhere). As another example, MTS 16 may receive the application from development environment simulation device 402. Accordingly, a method of providing a local simulation environment is depicted.

Referring now to FIG. 6, a flow diagram of a method of implementing a local simulation environment is depicted. In some embodiments, the method may be initiated or performed by one or more processors in response to one or more instructions stored by a computer-readable storage medium.

At 502, the method includes receiving a software suite that implements a local simulation environment using a local computer system. The local simulation environment may constitute at least a subset of the functionality of the network-based software development environment for a network-based computing platform. For example, user system 12 of FIG. 3 may receive local simulation environment 302. Local simulation environment 302 may implement at least a subset of functionality provided by application development environment 120. As another example, a client associated with user system 12 of FIG. 4 may receive development environment simulation device 402.

At 504, the method includes running one or more programming instructions in the local simulation environment using the local computer system. The local simulation environment may prevent a client from accessing one or more administrator features of the local simulation environment. For example, a client corresponding to user system 12 of FIG. 3 may run one or more programming instructions using local simulation environment 302. As another example, a client corresponding to development environment simulation device 402 may run one or more programming instructions using local simulation environment 404. In some embodiments, the client may subsequently send the one or more programming instructions to MTS 16 (e.g., using a user system or a development environment simulation device). Accordingly, a method of implementing a local simulation environment is depicted.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

Various operations described herein may be implemented by a computing device configured to execute program instructions that specify the operations. Similarly, various operations may be performed by circuitry desired or configured to perform the operations. In some embodiments, a non-transitory computer-readable medium has program instructions stored thereon that are capable of causing various operations described herein. As used herein, the term “processing element” refers to various elements or combinations of elements configured to execute program instructions. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors, as well as any combinations thereof.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
implementing a network-based computing platform that executes applications received from a plurality of clients, wherein the network-based computing platform includes a network-based software development environment for the network-based computing platform;
providing, to a particular client of the plurality of clients, a local simulation environment, wherein the local simulation environment constitutes at least a subset of the functionality of the network-based software development environment, and wherein the local simulation environment prevents the particular client from accessing one or more administrator features of the local simulation environment; and
receiving, from the particular client, an application executable on the network-based computing platform.

2. The method of claim 1, wherein providing the local simulation environment comprises sending, to the client, a development environment simulation device that includes the local simulation environment.

3. The method of claim 2, wherein the database system simulation device is dedicated hardware configured to implement the local simulation environment.

4. The method of claim 1, wherein providing the local simulation environment comprises initiating a remote download of the local simulation environment.

5. The method of claim 4, wherein the local simulation environment implements a virtual machine corresponding to the at least the subset of the network-based software development environment.

6. The method of claim 1, further comprising providing, to the particular client, a second local simulation environment, wherein the second local simulation environment constitutes a second subset of the functionality of the network-based software development environment, and wherein the second local simulation environment implements at least some functionality of the network-based software development not implemented by the local simulation environment.

7. The method of claim 6, wherein the second local simulation environment is configured to be networked together with the local simulation environment.

8. The method of claim 1, wherein the one or more administrator features include a command prompt associated with the local simulation environment.

9. The method of claim 1, wherein the one or more administrator features include access to a kernel of the local simulation environment.

10. The method of claim 1, wherein the local simulation environment restricts communications to a particular set of network ports.

11. The method of claim 1, wherein the network-based software development environment prevents the particular client from running applications for more than a threshold amount of time within a particular duration.

12. The method of claim 1, wherein the network-based software development environment prevents the particular client from submitting more than a particular number of requests to initiate applications associated with the client on the network-based software development environment within a particular duration.

13. A non-transitory computer-readable medium having computer instructions stored thereon that are capable of being executed by a computer system to cause operations comprising:
implementing a local simulation environment using a local computer system, wherein the local simulation environment constitutes at least a subset of functionality of a network-based software development environment for a network-based computing platform, and wherein the local simulation environment prevents a client from accessing one or more administrator features of the local simulation environment;
receiving an application corresponding to the network-based computing platform; and
executing the application using the at least the subset of the functionality of the network-based software development environment.

14. The non-transitory computer-readable medium of claim 13, wherein the operations further comprise implementing a second local simulation environment using the local computer system, wherein the second local simulation environment constitutes a second subset of the functionality of the network-based software development environment, and wherein the second local simulation environment implements at least some functionality of the network-based software development not implemented by the local simulation environment.

15. The non-transitory computer-readable medium of claim 14, wherein the second local simulation environment is configured to be networked together with the local simulation environment.

16. The non-transitory computer-readable medium of claim 14, wherein after receiving the second local simulation environment, the local computer system implements the at least some functionality of the network-based software development environment within the local simulation environment.

17. A method, comprising:
receiving a software suite that implements a local simulation environment using a local computer system, wherein the local simulation environment constitutes at least a subset of the functionality of a network-based software development environment for a network-based computing platform; and
running one or more programming instructions in the local simulation environment using the local computer system,
wherein the local simulation environment prevents a client from accessing one or more administrator features of the local simulation environment.

18. The method of claim 17, further comprising, subsequent to running the one or more programming instructions in the local simulation environment, sending the one or more programming instructions to the network-based computing platform.

19. The method of claim 18, further comprising running a variation of the one or more programming instructions in the local simulation environment prior to running the one or more programming instructions in the local simulation environment.

20. The method of claim 17, wherein receiving the software suite includes receiving the local computer system, wherein the local computer system includes dedicated hardware configured to implement the software suite.
